(19) United States
(12) Patent Application Publication
(10) Pub. No.: US 2025/0156483 A1
(43) Pub. Date: May 15, 2025

(54) METHOD AND COMPUTER SYSTEM FOR ELECTRONIC DOCUMENT MANAGEMENT

(71) Applicant: ATOS FRANCE, BEZONS (FR)

(72) Inventor: Yannick LECROART, La Grande Motte (FR)

(73) Assignee: ATOS FRANCE, BEZONS (FR)

(21) Appl. No.: 18/945,920

(22) Filed: Nov. 13, 2024

(30) Foreign Application Priority Data
Nov. 14, 2023 (EP) 23306975.6

(51) Int. Cl. G06F 16/93; G06F 16/22; G06F 16/23; G06F 16/25

(52) U.S. Cl. CPC G06F 16/93; G06F 16/2237; G06F 16/2264; G06F 16/2379; G06F 16/258

(57) ABSTRACT

The method comprises the steps, implemented by a computer system, of:
converting electronic documents in a first database (1100) into vectors of numbers;
inserting said vectors into a second vector database (1200);
receiving, via a conversational agent (1400), a query to search for information in the electronic documents;
generating, via a generative AI agent (1500) using the second database (1200), a response to the query;
in the event of non-validation of the response, receiving, via the conversational agent (1400), context data related to the circumstances of non-validation of the response;
identifying a source document to be updated in the first database (1100) on the basis of the query and/or context data;
determining an update action based on the context data and/or the query, via the generative AI agent (1500);
executing an update of the first database (1100) based on the update action.

This application claims priority to European Patent Application Number 23306975.6, filed 14 Nov. 2023, the specification of which is hereby incorporated herein by reference.

### BACKGROUND OF THE INVENTION

### Field of the Invention

At least one embodiment of the invention relates to the management of a set of electronic documents.

### Description of the Related Art

Within the scope of an IT project, such as the development of new software or the installation of an information system solution, documentation containing numerous electronic documents is created to allow communication of information relating to the IT project within a development team, with stakeholders and with end users. For example, the documents include a technical operating document, a developer's manual, a technical architecture document, a user's manual, etc. Such information facilitates maintenance, troubleshooting and training of users.

When a user wishes to access a specific piece of information in this documentation, he must browse each document, and/or a summary, or a table of contents, associated with each document in order to identify the document and the part of the document containing the information sought. Such a search for information is long and tedious.

The aim of one or more embodiments of the invention is to improve the situation, in particular to allow faster access to a desired piece of information in the documentation.

### BRIEF SUMMARY OF THE INVENTION

According to a first aspect, one or more embodiments of the invention relates to a computer-implemented method of managing electronic documents stored in a first database, comprising the steps, implemented by a computer system, of:
converting the electronic documents in the first database into vectors of numbers;
inserting said vectors into a second vector database;
receiving, via a conversational agent, a query to search for information in the electronic documents;
generating, via a generative artificial intelligence agent using the second vector database, a response to the query;
in the event of non-validation of the response, receiving, via the conversational agent, context data related to the circumstances of non-validation of the response;
identifying a source electronic document to be updated in the first database on the basis of the query and/or the context data;
determining an update action for the identified source electronic document on the basis of the context data and/or the query, via the generative artificial intelligence agent using the second vector database;
executing an update of the first database on the basis of the determined update action, then converting the electronic documents in the first database into vectors of numbers once again in order to update the second vector database.

At least one embodiment of the invention makes it possible to interact with a conversational agent to quickly access the contents of a set of electronic documents and automatically update the electronic document database, thereby further accelerating and facilitating subsequent access to desired information. The use of a conversational agent combined with a generative AI agent makes it easier to access desired information in the database and to update the database.

The steps of receiving context data, identifying an electronic document to be updated, determining an update action for this document and executing this update, are executed specifically and only in the event of non-validation of the response. Advantageously, in at least one embodiment, the steps of converting the electronic documents in the first database into vectors, and inserting said vectors into a second vector database are executed once again after updating the first database.

In at least one embodiment, the step of executing an update of the first database is executed after determining a plurality of update actions from a plurality of non-validated responses.

For example, the step of executing an update of the first database is executed if the number of non-validated responses has reached a predefined threshold.

The update actions determined following a succession of non-validated responses are stored in memory and executed in batches, in order to limit the number of updates to the electronic document database.

Advantageously, in at least one embodiment, the method comprises a step of reading a governance computer file, stored in memory, describing the electronic documents in the first database and operational parameters for controlling operations, implemented in order to execute at least one of the operations of converting the electronic documents into vectors, generating a response to the query, and executing an update of the second database.

The governance file is used to specify tools, such as software or applications or algorithms, and/or parameters that must be used by the computer system to execute tasks. The contents of the file can be modified, so that the system can be upgraded without having to modify a source code for executing system tasks.

In at least one embodiment, the method includes
a step of generating metadata associated with each data vector, describing information about the source electronic document from which said data vector originates,
said metadata being inserted into the second vector database in association with said corresponding data vector.

Metadata provides additional information about stored data. They can be used as vector attributes in the vector database to facilitate vector extraction.

Advantageously, in one or more embodiments, the step of generating a response to the query comprises a step of extracting at least one keyword from the query and a step of comparing the extracted keyword(s) and the metadata in the second database.

In at least one embodiment, the step of converting electronic documents into vectors comprises the steps of:
splitting each electronic document into smaller objects;
converting each object into a vector of numbers in a multi-dimensional space;
indexing the vectors.

Advantageously, in one or more embodiments, the step of converting the electronic documents into vectors comprises a preliminary step of pre-processing the electronic document data to correct and/or eliminate errors in the electronic documents.

At least one embodiment of the invention also relates to a computerized electronic document management system comprising:
a first database for storing electronic documents;
a second vector database;
a processor on which a conversational agent and a generative artificial intelligence agent are installed, and comprising means for implementing the steps of the previously defined method.

At least one embodiment of the invention further relates to a computer program comprising instructions which, when executed by a processor, implement the previously defined method.

### BRIEF DESCRIPTION OF THE DRAWINGS

The one or more embodiments will be better understood in light of the following detailed description and accompanying drawings, which are given by way of illustration only and therefore do not limit the disclosure.

FIG. 1 shows an overall schematic view of a system for managing a set of electronic documents, according to one or more embodiments of the invention.

FIG. 2 shows an example of a governance computer file, according to one or more embodiments of the invention.

FIG. 3 shows a flowchart of a method for managing a set of electronic documents, corresponding to an operation of the system shown in FIG. 1, according to one or more embodiments of the invention.

FIG. 4 shows a flowchart of the steps of converting electronic documents into vectors, according to one or more embodiments of the invention.

### DETAILED DESCRIPTION OF THE INVENTION

Various embodiments will now be described in more detail, by way of non-limiting examples, with reference to the drawings accompanying the disclosure and illustrating certain example embodiments.

The specific structural and functional details described herein are non-limiting examples. The example embodiments described herein are subject to various modifications and alternative forms. The subject matter of the disclosure may be embodied in many different forms and shall not be construed as being limited to only the one or more embodiments presented herein as illustrative examples. It should be understood that there is no intention to limit the one or more embodiments to the particular forms described in the remainder of this document.

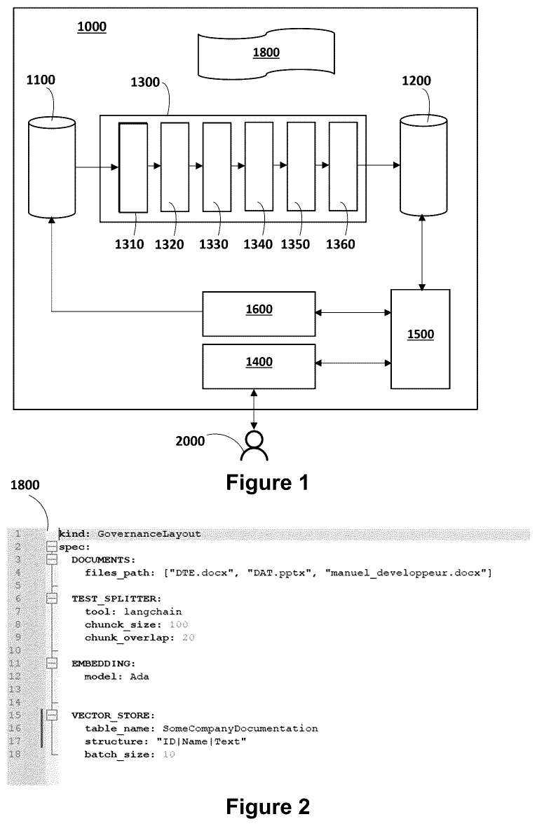

FIG. 1 shows an overall architecture of a system 1000 for managing a set of electronic documents, according to one or more embodiments of the invention. The system 1000 comprises several components that interact with each other to allow electronic documents to be managed, including access to information contained in the electronic documents and updating or modifying electronic documents to provide rapid access to the desired information.

The architecture of the overall system, or platform 1000 comprises a first database 1100, a second database 1200, a chain or system 1300 for converting electronic documents into vectors, a conversational agent 1400, a generative artificial intelligence (AI) agent 1500, and an update agent 1600.

The system 1000 also comprises user interface means, not shown.

A central control module, not shown, comprising one or more processors, controls the operation of the various components of the system 1000.

The system 1000 is implemented using hardware means and software means. Hardware means may comprise one or more processors. Software means may comprise applications, software, computer programs, and/or a set of program instructions and data.

The role of the first database 1100 is to store a set of electronic documents D1, D2, etc. These electronic documents form a documentation, for example the documentation for a software development project or for the installation of an information system. Each electronic document may comprise text data, and optionally image data. There are numerous file formats available for creating documentation, for example plain text formats (txt, Markdown, AsciiDoc, etc.), word processing formats (docx, odt, pdf, etc.), presentation formats (pptx, odp, OpenDocument, pdf, etc.), spreadsheet formats (clsx, ods, OpenDocument, etc.), HTML file formats (HTML, MHTML, CHM, etc.), specialized file formats for technical documentation (DITA, DocBook, reStructuredText, etc.), database file formats (SQL, CSV, etc.), online publishing formats (Wiki, CMS, etc.), source code documentation formats (C, C++, Java, Python, etc.), etc.

The function of the conversion chain 1300 is to convert electronic documents from the first database 1100 into vectors of numbers and to insert these vectors into the second vector database 1200. The conversion chain 1300 comprises several components.

A first component 1310 of the conversion chain 1300 has a pre-processing function for electronic documents stored in the first database 1100. Pre-processing, according to one or more embodiments of the invention, may involve eliminating and/or correcting errors, inconsistencies or duplicates and/or adding missing information (for example, missing words and/or characters). The pre-processing component 1310 may comprise a spelling and/or grammar checker to detect and automatically correct spelling and/or grammar errors in text data of electronic documents in the first database 1100.

A second component 1320 of the conversion chain 1300 is a splitting module arranged to split an electronic document, known as the “source document”, into smaller elements or objects. In at least one embodiment, the source document contains text and the splitting module 1320 is arranged to split the source document text into objects or sections of text. An object or section of text may contain a word, a group of words or a sentence from the source document. The splitting module 1320 may be implemented using a software tool for splitting text into sentences, paragraphs or smaller units, such as spaCy, NLTK (Natural Language Toolkit), Stanford NLP, TextBlob, SentencePiece, etc.

A third component 1330 of the conversion chain 1300 is a metadata generator whose function is to generate metadata for each object resulting from the splitting of a source document. The metadata relating to an object describes information about the source document from which this object originates. The metadata may comprise descriptive data relating to the source document and/or part of this source document from which the object originates. For example, in at least one embodiment, the metadata may comprise keywords describing the document and/or the part of the document from which the object originates. These keywords can be obtained by processing or analyzing the source document and/or the part of the source document from which the object originates using a tool for automatic extraction of key or essential information. For example, keywords can be extracted from a denomination (for example, title, file name, etc.) of the source document and/or part of the source document from which the object originates in order to generate the metadata.

A fourth component 1340 of the conversion chain 1300 is a vector embedding module, whose role is to convert each object produced by the splitting module 1320 into a vector of numbers, or numeric vector, or numeric data vector, in a multi-dimensional space. Vectors are numerical representations of document objects, converted into sequences of numbers, allowing a computer or a processor to easily understand the relationships between the objects. For example, the word “cat” can be represented by a vector of numbers, such as [0.2, −0.5, 0.7 etc.]. The distance between two vectors measures their relationship. Small distances suggest high similarity and large distances suggest low similarity. The vector embedding module 1340 may use a vector embedding or representation tool such as ADA, Word2Vec, FastText, etc.

A fifth component 1350 of the conversion chain 1300 is an indexing module. The role of this component 1350 is to index the vectors produced by the vector embedding module 1340 using a multi-dimensional indexing method or technique such as PQ (Product Quantization), LSH (Locality-Sensitive Hashing) or HNSW (Hierarchical Navigable Small World). These vector indexing methods allow multi-dimensional vectors to be indexed according to their location and distribution in multi-dimensional space. After indexing, each vector is associated with a data structure allowing for faster searching in the second vector database 1200. Indexing allows data to be organized in such a way as to facilitate spatial search operations in multi-dimensional space.

The conversion chain 1300 may also comprise an insertion component 1360 whose role is to insert the vectors and other data (metadata, vector indexing data structures) produced by the other components of the chain 1300 into the vector database 1200. The component 1360 also defines or determines the structure of the database 1200.

The role of the conversational agent 1400, or “chatbot”, is to converse with a user. By way of an illustrative and non-limiting example, in one or more embodiments, the conversational agent may be developed on a Rasa open source platform that allows the development of conversational chatbots and virtual assistants in Python. The conversational agent 1400 may also use a software tool for automatic keyword extraction.

The function of the generative artificial intelligence, or generative AI, agent or system 1500 is to create answers to queries or requests to search for information in the electronic documents in the database 1100. Its role is also to generate questions, supplied to the conversational agent 1400 interacting with a user 2000, aimed at obtaining context data related to the circumstances of non-validation of a response, and to generate an update action for the database 1100, as will be explained later in the description of the method. The generative AI agent 1500 may be based on a large language model, or LLM.

The role of the update agent or module or system 1600 is to update the first database 1100 of electronic documents, via the conversational agent 1400 and the generative AI agent 1500, as will be described in greater detail in the description of the method. It comprises a Reinforcement Learning agent.

Reinforcement learning within the platform or system 1000 is performed by symbolic AI (Artificial Intelligence) on the basis of one or more pieces of user feedback. This is an approach to artificial intelligence that relies on the manipulation of symbols and formal representations in order to perform cognitive tasks and solve problems. Unlike other AI approaches, such as machine learning and neural networks, which focus on learning from raw data, symbolic AI relies on logical rules, declarative knowledge and reasoning processes. These logical rules are implemented through questions and answers with a user 2000. The features of symbolic AI, in one or more embodiments, may comprise some or all of the following elements:
knowledge representation: in symbolic AI, knowledge is often represented explicitly in the form of symbols, predicates, logical rules, graphs, etc. These representations capture the semantics and structure of information;
symbolic reasoning: symbolic AI uses logical and symbolic reasoning to process and manipulate represented knowledge. This involves the application of deduction, inference and problem-solving rules;
symbol manipulation: symbolic AI systems manipulate symbols and abstract entities to solve problems. For example, they can use logical operations such as knowledge modeling, rule induction and solution finding;
transparency and explainability: symbolic AI often offers greater transparency and explainability than other AI approaches. This means that decisions made by the system can be traced back to logical rules or specific knowledge, making it easier to understand how the system works.

Symbolic AI thus corresponds to expert reasoning making it possible to determine an anomalous element that needs to be modified on the basis of user feedback.

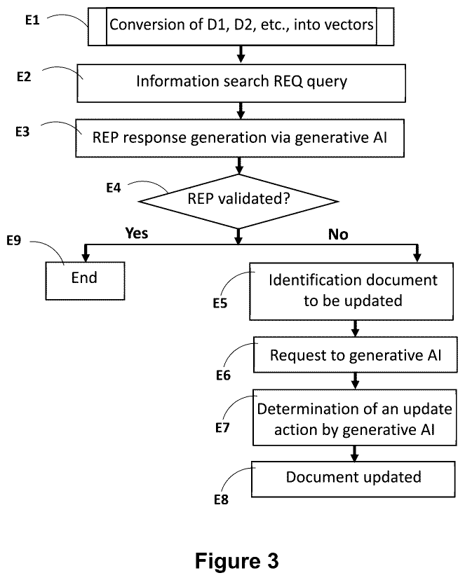

In at least one embodiment, the system 1000 may also comprise a governance and/or configuration computer file 1800, stored in memory. This computer file may be a declarative file, for example of the CSV, YAML, XML or other type. An example of a governance file 1800 is shown in FIG. 2, according to one or more embodiments of the invention. It contains naming and/or description information for the electronic documents contained in the first database 1100, for example by indicating a file name for each electronic document. It also describes operational parameters for controlling operations of the system 1000, for use by entities of the system 1000 to execute various operations. By way of an illustrative and non-limiting example, in at least one embodiment, the governance file 1800 specifies:
a splitting software tool for use by the module 1320 to split documents into objects, and optionally splitting parameters (for example, object size, object overlap size, etc.);
a vector embedding software tool for use by the module 1340 to convert objects into vectors of numbers;
a software tool for extracting key words;
information, for example a table name and/or a structure, to define a structure for the vector database 1200;
an update frequency according to which the first database 1100 is updated after a certain number of non-validated responses.

FIG. 2, according to one or more embodiments of the invention, shows a purely illustrative example of a governance file 1800 specifying the documents contained in the database 1100, a “langchain” splitting tool and splitting parameters, an “ADA” vector integration tool, parameters relating to the vector database (table name and table structure), and an update frequency parameter (“10”).

During operation, each element of the system 1000 can access the file 1800 and read the operational parameters therein for controlling the operation or task to be implemented.

The file 1800 can be modified, which means that the tools and/or operational parameters of the system 1000 can be upgraded, without having to modify a source code that allows tasks and operations to be executed by the system 1000.

The control module (not shown) is arranged to control the operation of the system 1000. It may comprise a task orchestrator for scheduling the tasks executed by the system 1000.

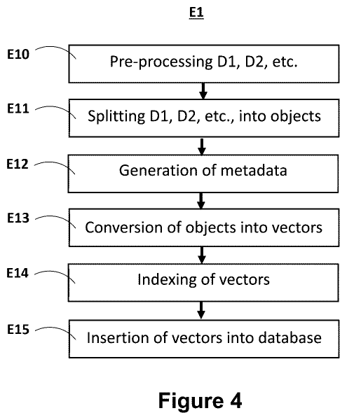

We will now describe a method for managing and updating electronic documents D1, D2, etc., corresponding to the operation of the system 1000, with reference to FIGS. 3 and 4, according to one or more embodiments of the invention. Electronic documents D1, D2, etc., are stored in the database 1100. These documents D1, D2, etc., may comprise text, images and/or any other type of data.

In step E1, electronic documents D1, D2, etc., in the database 1100 are converted into vectors of numbers and inserted into the vector database 1200. Step E1 may comprise several steps E10 to E15, described below.

In step E10, the pre-processing module 1310 performs pre-processing of the electronic documents D1, D2, etc., to eliminate and/or correct errors, inconsistencies or duplicates and/or add missing data (for example, words, characters, etc.). The pre-processing may comprise automatic spelling and/or grammar correction in the text data of electronic documents D1, D2, etc.

In step E11, the splitting module 1320 splits each document into smaller objects. For example, an object may comprise a word, a group of words or a sentence. It could also comprise an image or a fraction of an image, or any other type of data.

In step E12, the metadata generator 1330 determines, for each object produced by the splitting module 1320 in step E11, metadata describing information about the source document from which the object originates. For example, the metadata may contain data designating the source document and/or a part (chapter, section, paragraph, etc.) of the source document from which the object originates. Metadata may for example contain keywords extracted from the document and/or part of the document from which the object originates (for example, keywords extracted from a title or name of the document or part of the document, a file name of the document, etc.).

In step E13, the objects produced in step E11 are converted by the vector integration module 1340 into vectors of numbers in a multi-dimensional space.

In step E14, the vectors resulting from step E13 are indexed by the indexing module 1350. A data structure is created and associated with each vector. It allows faster searching in the vector database 1200.

In step E15, the vectors resulting from the conversion step E13 are inserted into the vector database 1200 by the insertion component 1360. In the vector insertion step, the metadata generated in step E12 and the indexing data structures generated in indexing step E14 are also inserted into the vector database 1200 and associated in the vector database 1200 with the corresponding vectors. Thus, in the vector database 1200, each vector of numbers is associated with the metadata associated with the object of the source document from which this vector originates and with the indexing data structure associated with this vector.

Before inserting data into the vector database 1200, the insertion component 1360 determines and/or defines the data structure of the vector database 1200 on the basis of the information specified in the governance file 1800. It then establishes a connection with the database 1200, via an automated process executed by the task orchestrator for example. Data is inserted into the database 1200 on the basis of insertion instructions generated by the insertion component 1360. The insertion instructions specify the structure of the database 1200, for example a table or a class of entities into which the data is to be inserted.

After converting electronic documents D1, D2, etc. into vectors and inserting the vectors and their attributes (metadata, indexing data structure) into the vector database 1200, the system 1000 receives a query to search for information in electronic documents D1, D2, etc., via the conversational agent 1400, in step E2. The query can be entered by a user using user interface means 1700. In step E2, the user can interact with the conversational agent 1400 in the form of one or more question-answer sequences. The REQ query may therefore comprise one or more successive questions asked by the user via the conversational agent 1400.

As an illustrative example, with reference to FIG. 3, the REQ query might be “What are the PostGresQLdatabase connection identifiers?”

In step E2, the conversational agent 1400 extracts key information, in this case keywords, from the REQ information query and transmits the keywords to the generative AI agent 1500.

In a step E3, the generative AI agent generates an REP response to the query on the basis of the REQ query, herein on the basis of the keywords extracted from the REQ query, using the vector database 1200. In step E3, the generative AI agent 1500 searches the vector database 1200 for vectors related to the REQ query, herein with the keywords extracted from the REQ query. In at least one embodiment, the generative AI agent 1500 calculates, for all or some of the vectors in the vector database 1200, proximity and/or similarity scores with the keyword(s) extracted from the REQ query, and determines (extracts) the vectors in the vector database 1200 with the best scores. The generative AI agent 1500 then generates a REP response based on the vectors determined or extracted from the vector database 1200.

If the user interacts with the conversational agent 1400 in the form of one or more question-answer sequences in step E3, the REP response comprises all of the responses to the series of questions making up the REQ query.

In the example shown in FIG. 3, in at least one embodiment, the REP response indicates that the PostGresQLdatabase connection identifiers were not found in documents D1, D2, etc.

In step E4, the conversational agent 1400, via the generative AI agent, interacts with the user to determine whether the REP response to the REQ query is valid.

If the REP response is validated by the user in step E4, the process of updating the database 1100 is interrupted in step E9.

If the REP response is not validated by the user in step E4, context data related to the circumstances of non-validation of the REP response is received, obtained during an interaction (for example in the form of questions/answers) between the user and the conversational agent 1400 in step E4. This context data contains explanatory information about the non-validation of the REP response. They can be obtained in response to questions, generated by the generative AI agent 1500 and aimed at determining the circumstances or reasons for non-validation of the REP response, during an interaction between the conversational agent 1400 and the user in step E4. The REQ query, optionally the REP response, and the context data related to the circumstances of non-validation of the response may be transmitted by the conversational agent 1400 to the update agent 1600.

In the illustrative example shown in FIG. 3, in step E4, the context data related to the circumstances of non-validation of the REP response indicates that the PostGresQLdatabase connection identifiers are missing from documents D1, D2, etc., in the database 1100.

In a step E5, the update agent 1600 identifies a source electronic document from the database 1100 to be updated and/or a specific part of a source electronic document from the database 1100 to be updated, based on the REQ query and context data related to the circumstances of non-validation of the REP response to this REQ query. For this purpose, the agent 1600 can use the vector database via the metadata for the document and/or the part of the document to be updated. In step E5, the update agent 1600 can retrieve the document to be updated from the database 1100.

In the example shown in FIG. 3, in step E5, the update agent 1600 identifies a document for describing and using the PostGresQLdatabase, contained in the database 1100, and a paragraph of this document relating to accessing the PostGresQLdatabase.

In step E6, the update agent 1600 asks the generative AI agent 1500 to determine an update action for the document identified and/or the part of the document identified in step E5. In step E6, the update agent 1600 can transmit to the generative AI agent 1500 the context data related to the circumstances of non-validation of the REP response and optionally the REQ query for which the REP response is non-validated.

In a step E7, the generative AI agent 1500 determines an update action for the document identified in step E5 and/or the part of the document identified in step E5, using the vector database 1200, on the basis of context data relating to the circumstances of non-validation of the REP response and/or the REQ query whose REP response is non-validated. The generative AI agent 1500 provides the determined update action to the update agent 1600. More precisely, the generative AI agent 1500 transmits to the update agent 1600 instructions and data relating to the update action, typically to add, modify and/or delete data in the document or the part of the document to be updated. The data to be added or removed may comprise text, images and/or any other type of data.

In the example shown in FIG. 3, the update action consists of adding a section to the PostGresQLdatabase description and use document, containing information on how to connect to the PostGresQLdatabase. This information includes for example:
postGresQLdatabase connection identifiers; and/or
a link or hyperlink to automatically switch from the document for describing and using the PostGresQLdatabase to an interface for accessing the PostGresQLdatabase (for example a web page) allowing identifiers for connecting to this database to be created and/or entered; and/or
rules for creating identifiers to access the PostGresQLdatabase.

In a step E8, the update agent 1600 performs an update operation on the database 1100 by executing the update action specified by the generative AI agent 1500. It updates the identified document and/or the identified part of a document in the database 1100, based on the instructions and data supplied by the generative AI agent 1500.

Before executing each of at least some of tasks E10 to E15, E2 to E8 implemented by the system 1000, a step is carried out to read the governance computer file 1800, in order to control and/or configure the execution of these tasks on the basis of the data contained in the file 1800.

After the update operation E8, step E1 is executed once again on the updated database 1100. The vector database 1200 is thus also updated.

Alternatively, in at least one embodiment, step E8 of executing an update of the database 1100 is executed if the number of non-validated responses has reached a predefined threshold. Update E8 may thus include a plurality of update actions in the first database determined from a plurality of non-validated responses.

This could include an evaluation phase for the updated databases 1100 and 1200, during which the two versions (old and updated) of the databases 1100 and 1200 are compared.

Those skilled in the art will understand that all the block diagrams presented herein show conceptual views, given by way of example, of circuits incorporating the principles of the disclosure of one or more embodiments of the invention.

Each function, block, step described may be implemented in hardware, software, firmware, middleware, microcode or any suitable combination thereof. If they are implemented in software, the functions or blocks of the block diagrams and flowcharts can be implemented by computer program instructions/software codes, which can be stored or transmitted on a computer-readable medium, or loaded onto a general-purpose computer, special-purpose computer or other programmable processing device and/or system, so that the computer program instructions or software codes running on the computer or other programmable processing device create the means to implement the functions described herein by way of one or more embodiments of the invention.

Although aspects of one or more embodiments of the invention have been described with reference to specific embodiments, it should be understood that these embodiments merely show the principles and applications of the various example embodiments of the invention. It is therefore understood that numerous modifications may be made to the illustrative embodiments and that other arrangements may be devised without departing from the spirit and scope of the invention as determined on the basis of the claims and their equivalents.

Advantages and solutions to problems have been described above with regard to specific one or more embodiments of the invention. However, advantages, benefits, solutions to problems, and any element which may cause or result in such advantages, benefits or solutions, or cause such advantages, benefits or solutions to become more pronounced shall not be construed as a critical, required, or essential feature or element of any or all of the claims.

1. A computer-implemented method of managing electronic documents stored in a first database, said computer-implemented method implemented by a computer system and comprising:
converting the electronic documents in the first database into vectors of numbers;
inserting said vectors into a second vector database;
receiving, via a conversational agent, a query to search for information in the electronic documents;
generating, via a generative artificial intelligence agent using the second vector database, a response to the query;
in an event of non-validation of the response, receiving, via the conversational agent, context data related to circumstances of said non-validation of the response;
identifying a source electronic document to be updated in the first database based on one or more of the query and the context data;
determining an update action for the source electronic document that is identified based on one or more of the context data and the query, via the generative artificial intelligence agent using the second vector database;
executing an update of the first database based on the update action that is determined, then converting the electronic documents in the first database into vectors of numbers once again to update the second vector database.

2. The computer-implemented method according to claim 1, wherein the converting the electronic documents in the first database into vectors, and the inserting said vectors into the second vector database are executed once again after updating the first database.

3. The computer-implemented method according to claim 1, wherein the executing the update of the first database is executed after determining a plurality of update actions from a plurality of non-validated responses.

4. The computer-implemented method according to claim 3, wherein the executing the update of the first database is executed if a number of non-validated responses of said plurality of non-validated responses has reached a predefined threshold.

5. The computer-implemented method according to claim 1, further comprising reading a governance computer file, stored in memory, describing the electronic documents of the first database and operational parameters for controlling operations, implemented in order to execute at least one of the converting the electronic documents into said vectors, the generating the response to the query, and the executing the update of the second vector database.

6. The computer-implemented method according to claim 1, further comprising
generating metadata associated with each data vector, describing information about the source electronic document from which said each data vector originates,
said metadata being inserted into the second vector database in association with a corresponding data vector.

7. The computer-implemented method according to claim 6, wherein the generating the response to the query comprises extracting at least one keyword from the query and comparing the at least one keyword that is extracted and the metadata in the second vector database.

8. The computer-implemented method according to claim 1, wherein the converting the electronic documents into said vectors comprises
splitting each electronic document of said electronic documents into smaller objects;
converting each object of said smaller objects into a vector of numbers in a multi-dimensional space;
indexing the vectors.

9. The computer-implemented method according to claim 8, wherein the converting the electronic documents into said vectors comprises a preliminary step of pre-processing data of the electronic documents to one or more of correct and eliminate errors in the electronic documents.

10. A computerized electronic document management system comprising:
a first database that stores electronic documents;
a second vector database;
a processor on which a conversational agent and a generative artificial intelligence agent are installed, and wherein said processor comprises instructions configured to implement a computer-implemented method of managing the electronic documents stored in said first database, said computer-implemented method comprising
converting the electronic documents in the first database into vectors of numbers;
inserting said vectors into the second vector database;
receiving, via the conversational agent, a query to search for information in the electronic documents;
generating, via the generative artificial intelligence agent using the second vector database, a response to the query;
in an event of non-validation of the response, receiving, via the conversational agent, context data related to circumstances of said non-validation of the response;
identifying a source electronic document to be updated in the first database based on one or more of the query and the context data;
determining an update action for the source electronic document that is identified based on one or more of the context data and the query via the generative artificial intelligence agent using the second vector database;
executing an update of the first database based on the update action that is determined, then converting the electronic documents in the first database into vectors of numbers once again to update the second vector database.

11. A non-transitory computer program comprising instructions which, when they are executed by a processor, cause the processor to implement a computer-implemented method of managing electronic documents stored in a first database, said computer-implemented method comprising
converting the electronic documents in the first database into vectors of numbers;
inserting said vectors into a second vector database;
receiving, via a conversational agent, a query to search for information in the electronic documents;
generating, via a generative artificial intelligence agent using the second vector database, a response to the query
in an event of non-validation of the response, receiving, via the conversational agent, context data related to circumstances of said non-validation of the response;
identifying a source electronic document to be updated in the first database based on one or more of the query and the context data;
determining an update action for the source electronic document that is identified based on one or more of the context data and the query via the generative artificial intelligence agent using the second vector database;
executing an update of the first database based on the update action that is determined, then converting the electronic documents in the first database into vectors of numbers once again to update the second vector database.
